(19) United States
(12) Patent Application Publication
(10) Pub. No.: US 2021/0020124 A1
(43) Pub. Date: Jan. 21, 2021

(54) POSITION DETECTION DEVICE, DISPLAY DEVICE, AND METHOD FOR DETECTING POSITION OF DISPLAY DEVICE

(71) Applicant: NEC DISPLAY SOLUTIONS, LTD., Tokyo (JP)

(72) Inventor: Isamu KENMOCHI, Tokyo (JP)

(73) Assignee: NEC Display Solutions, Ltd., Tokyo (JP)

(21) Appl. No.: 16/975,463

(22) PCT Filed: Mar. 15, 2018
(86) PCT No.: PCT/JP2018/010198

§ 371 Date: Aug. 25, 2020

(51) Int. Cl. G09G 3/36; G06F 3/147; G06F 3/14

(52) U.S. Cl. CPC G09G 3/36; G09G 2356/00; G06F 3/1407; G06F 3/147

(57) ABSTRACT

A position detection device has: a light sensor including a first light detection unit being located at a position facing a display screen on a first display device, and a second light detection unit being located at a position facing a display screen on a second display device that is provided adjacent to the first display device; and a position detection unit configured to detect a distance across a non-display region between the display screen of the first display device and the display screen of the second display device based on results of detection, by the first light detection unit, of a position adjustment image displayed on the display screen of the first display device, results of detection, by the second light detection unit, of a position adjustment image displayed on the display screen of the second display device, and display content of the position adjustment images.

### TECHNICAL FIELD

The present invention relates to a position detection device, a display device, and a method for detecting the position of a display device.

### BACKGROUND ART

There are cases in which multiple display devices are installed in an array to construct a multi-display system, and a single image is displayed by means of these multiple display devices. In such cases, each display device is sent the same image from a video signal supply device, and based on the relationship between the location at which that display device is installed relative to the locations at which the other display devices are installed in the multi-display system, an image of the area to be displayed by that display device, cut out from the single image in accordance with the non-display portions on the other display devices, is displayed, in an enlarged or reduced manner, on that display device. By performing such processes in each display device, a single image can be displayed on the entire multi-display system.

In this case, the display devices have frame portions on the outer periphery of the display regions. When multiple display devices are installed in an array, images cannot be displayed at the frame portions between adjacent display devices. The distance from the outer periphery of the display region in a display device to the outer periphery of the housing of the display device (the distance represented by the width of the frame portion) is known. By taking this distance into consideration and using it in calculations for enlarging or reducing images to account for the non-display portions, it becomes possible to display the images in adjacent display devices so as to fit together in a naturally appearing manner.

However, when multiple display devices are installed in an array, there are cases in which the outer peripheries of the housings of the display devices become warped or gaps are formed between the display devices. In such cases, the distances between the multiple display devices due to the warping and the gaps are unknown. For this reason, the non-display portions that are formed because of the distances between the multiple display devices due to warping or gaps cannot be used in the calculations for enlarging or reducing the images. Thus, when the multiple display devices are viewed, there will be differences from the single image.

### CITATION LIST

### Patent Literature

### Patent Document 1

Japanese Unexamined Patent Application, First Publication No. 2007-240936

### SUMMARY OF INVENTION

### Problem to be solved by the Invention

A problem to be solved is that the distances of non-display portions between adjacent display devices cannot be determined with good precision.

### Means for Solving the Problem

According to first aspect of the present invention is a position detection device for a display device, the position detection device includes: a light sensor including a first light detection unit and a second light detection unit that detect light from pixels, provided such that the first light detection unit is located at a position facing a display screen on a first display device, and the second light detection unit is located at a position facing a display screen on a second display device that is provided adjacent to the first display device; and a position detection unit configured to detect a distance across a non-display region between the display screen of the first display device and the display screen of the second display device based on results of detection, by the first light detection unit, of a position adjustment image displayed on the display screen of the first display device, results of detection, by the second light detection unit, of a position adjustment image displayed on the display screen of the second display device, and display content of the position adjustment images.

According to second aspect of the present invention is a method for detecting a position of a display device, wherein a light sensor including a first light detection unit and a second light detection unit that detect light from pixels, and being provided such that the first light detection unit is located at a position facing a display screen on a first display device, and the second light detection unit is located at a position facing a display screen on a second display device that is provided adjacent to the first display device; the method includes detecting, by a position detection unit, a distance across a non-display region between the display screen of the first display device and the display screen of the second display device based on results of detection, by the first light detection unit, of a position adjustment image displayed on the display screen of the first display device, results of detection, by the second light detection unit, of a position adjustment image displayed on the display screen of the second display device, and display content of the position adjustment images.

### Advantageous Effects of Invention

According to the present invention, the distances of non-display portions between adjacent display devices can be well determined.

### BRIEF DESCRIPTION OF DRAWINGS

FIG. 1 is a schematic block diagram for explaining the structure of a display system applying a position detection device according to a first embodiment.

FIG. 2 is a diagram for explaining the case in which a video signal is displayed on a display system 1000.

FIG. 3 is an enlarged view of a portion of an area that is to be a non-display portion.

FIG. 4 is a diagram for explaining the relationship between a light detection sensor 104 and display devices.

FIG. 5A is a diagram for explaining the relationship between a light detection unit and a position-detecting display pattern.

FIG. 5B is a diagram for explaining the relationship between a light detection unit and a position-detecting display pattern.

FIG. 5C is a diagram for explaining the relationship between a light detection unit and a position-detecting display pattern.

FIG. 6 is a diagram for explaining horizontal position detection in a display device.

FIG. 7 is a diagram representing a state in which a light detection sensor 104 is mounted on display surfaces near frame portions at which display devices face each other.

FIG. 8A is a diagram for explaining a state in which two display devices are not installed so as to be parallel to each other.

FIG. 8B is a diagram for explaining a state in which two display devices are not installed so as to be parallel to each other.

FIG. 9 is a diagram representing the state in which a light detection sensor 104 is mounted on display surfaces near frame portions at which display devices face each other.

FIG. 10 is a block diagram representing the structure of a display device 1A according to a second embodiment.

FIG. 11 is a diagram representing the arrangement state of a display system formed from four display devices.

FIG. 12 is a flow chart for explaining operations for performing position detection in the display device formed from four display devices.

FIG. 13A is a drawing for explaining a case in which a video signal is displayed by using position information from light detection units.

FIG. 13B is a drawing for explaining a case in which a video signal is displayed by using position information from light detection units.

FIG. 13C is a drawing for explaining a case in which a video signal is displayed by using position information from light detection units.

FIG. 13D is a drawing for explaining a case in which a video signal is displayed by using position information from light detection units.

FIG. 14 is a flow chart for explaining a position detection process performed by a display device that is a master device or by a PC.

FIG. 15A is a drawing representing the case in which a display system is formed from four display devices.

FIG. 15B is a drawing representing the case in which a display system is formed from four display devices.

FIG. 15C is a drawing representing the case in which a display system is formed from four display devices.

FIG. 15D is a drawing representing the case in which a display system is formed from four display devices.

FIG. 15E is a drawing representing the case in which a display system is formed from four display devices.

FIG. 16 is a drawing indicating the structure of a position detection device 600 according to a third embodiment.

### DESCRIPTION OF EMBODIMENTS

Hereinafter, embodiments of the present invention will be explained.

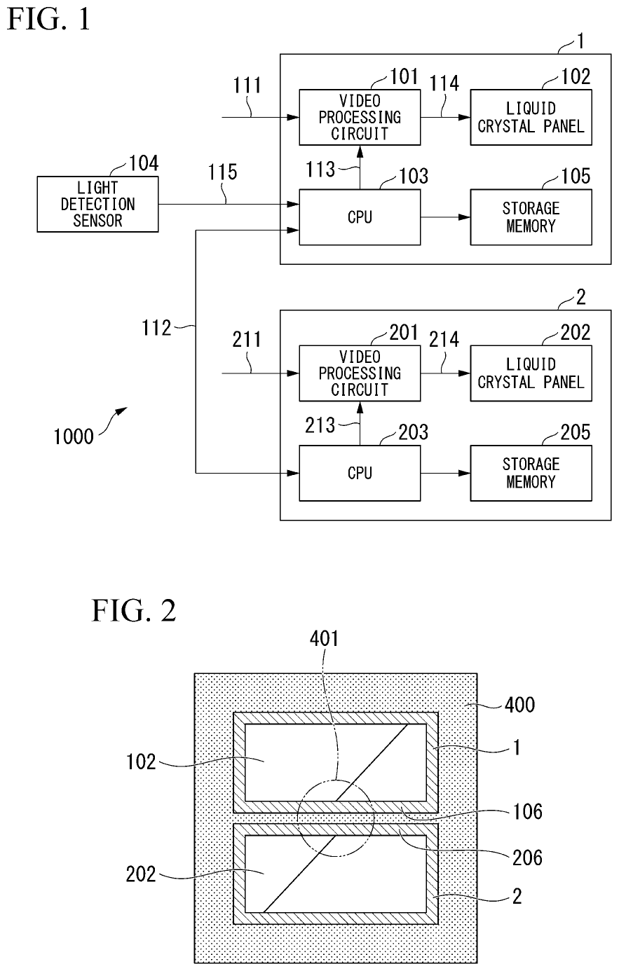

FIG. 1 is a schematic block diagram for explaining the structure of a display system applying a position detection device according to a first embodiment. In this embodiment, the display system is a display system in which multiple display devices are arrayed so as to be adjacent to each other and the display screens on these multiple display devices are used to display a single video signal. For example, the display system is a multi-display system.

In this drawing, the display system 1000 has a video display device 1, a video display device 2 and a light detection sensor 104.

The video display device 1 and the video display device 2 are adjacent to each other in either the lengthwise direction or the widthwise direction of the display screens of the video display devices, and are able to display a single video signal on these two display screens. In this embodiment, the case in which the display system 1000 has two display devices will be explained. However, the display system may be formed by providing multiple display devices in both the longitudinal direction and the lateral direction, so that there are N (N being a natural number equal to or greater than 2) display devices in the longitudinal direction (for example, the widthwise direction) and M (M being a natural number equal to or greater than 2) display devices in the lateral direction (for example, the longitudinal direction), so that there are N×M display devices lying adjacent to each other.

Additionally, in this embodiment, the display device 2 is arranged adjacent to the display device 1 in the widthwise direction of the display screen thereof. As a result thereof, the display system 1000 has an array of two display devices in the longitudinal direction and one display device in the lateral direction, and the two display screens thereon can be used to display a single video signal. For example, when displaying a single video signal, the video signal is divided in the direction in which the display devices are arrayed, a video signal corresponding to the divided upper screen is displayed on the display device 1 after being enlarged or reduced so as to correspond to the screen size of the display device 1, and a video signal corresponding to the divided lower screen is displayed on the display device 2 after being enlarged or reduced so as to correspond to the screen size of the display device 2. Thus, a single video signal can be displayed by means of the display device 1 and the display device 2.

The light detection sensor 104 has multiple light detection units that detect light from pixels of the display panels in the display system 1000. The light detection sensor 104 is provided so that, among the multiple light detection units, a first light detection unit is located at a position facing the display screen of the first display device, and a second light detection unit is located at a position facing the display screen of the second display device. The light detection sensor 104 supplies detection results obtained by detecting light, as a light sensor detection signal 115, to the CPU 103 of the display device 1.

The video display device 1 has a video processing circuit 101, a liquid crystal display panel 102, a central processing device (hereinafter also referred to as a CPU) 103 and a storage memory 105.

The video processing circuit 101 inputs a video signal 111 that has been supplied from an external source. The external source that supplies this video signal may be a device that outputs data that is to form content, examples of which include computers, video playback devices and the like. The video processing circuit 101 outputs the video signal to the liquid crystal panel 102, thereby displaying the video signal on the liquid crystal panel 102.

The video processing circuit 101 processes the input video signal 111 on the basis of control by the CPU 103, and outputs the processed video signal, as a liquid crystal panel video signal 114, to the liquid crystal panel 102. This processing includes, for example, a process for converting the video signal 111 to a liquid crystal panel video signal 114 for displaying on the liquid crystal panel 102. The video processing circuit 101 has the function of a liquid crystal driving circuit, is able to drive the liquid crystal panel 211 in accordance with the liquid crystal panel video signal, and can, as a result thereof, display an image in accordance with the liquid crystal panel video signal on the liquid crystal display panel 211.

The liquid crystal panel 102 displays an image in accordance with the video signal by driving each pixel element in accordance with the drive signal output from the video processing circuit 101.

The CPU 103 receives, as an input, a light sensor detection signal 115 supplied from the light detection sensor 104.

The CPU 103 has a position detection function for detecting the distance across a non-display region between the display screen of the first display device and the display screen of the second display device based on the results of detection, by the first light detection unit, of a position adjustment image displayed on the display screen of the first display device, the results of detection, by the second light detection unit, of a position adjustment image displayed on the display screen of the second display device, and the display content of the position adjustment images.

Additionally, the CPU 103 controls the video processing circuit 101 by outputting, to the video processing circuit 101, a video processing circuit control signal 113, which is a signal for controlling the video processing circuit 101.

Additionally, the CPU 103 outputs a video display device inter-device control signal 112 to the CPU 203. As a result thereof, the CPU 103 is able to control the CPU 203.

The storage memory 105 has the function of recording various types of data in accordance with instructions from the CPU 103, and the function of reading out recorded data in accordance with instructions from the CPU 103 and supplying the data to the CPU 103.

This storage memory 105 may, for example, be a volatile memory or a non-volatile memory, and more specifically, may be an HDD (hard disk), an SRAM (static RAM) or the like.

The video display device 2 basically has a structure similar to that of the video display device 1. Here, the differing structures will be explained, and explanations of the similar structures will be omitted.

In the video display device 2, the video processing circuit 201 inputs a video signal 211. This video signal 211 may be the same video signal as the video signal 111. In other words, a single video signal is input as the video signal 111 to the video processing circuit 101, and as the video signal 211 to the video processing circuit 201.

The video processing circuit 201 outputs the liquid crystal panel video signal 214 to the liquid crystal panel 202.

The CPU 203 receives, as an input, the video display device inter-device control signal 112 output from the CPU 103, and based on this video display device inter-device control signal 112, outputs a control signal to the video processing circuit 201. By using this video display device inter-device control signal 112, the CPU 203 can execute various processes, such as displaying a position-detecting display pattern to be described below, in response to instructions from the CPU 103.

The CPU 203 outputs a video processing circuit control signal 213, which is a signal for controlling the video processing circuit 210.

The above-mentioned CPU 103 and CPU 203 may be formed from electronic circuits dedicated thereto. Additionally, the CPU 103 and CPU 203 may be formed so as to include an A/D conversion unit and a D/A conversion unit. For example, if an electrical signal obtained from the light detection sensor 104 is an analog signal, then the CPU 103 and the CPU 203 may convert this analog signal to a digital signal by means of the A/D conversion unit, and may perform signal processing on the resulting digital signal.

FIG. 2 is a drawing for explaining the case in which a video signal is displayed on the display system 1000.

In this drawing, a background 400 is the background that appears behind the display device 1 and the display device 2 when the display device 1 and the display device 2 have been installed and the display device 1 and the display device 2 are viewed from the display screens side.

The display device 1 and the display device 2 are arranged adjacent to each other so as to be aligned in the longitudinal direction.

A frame portion 106 is provided along the outer periphery of the liquid crystal display panel 102 of the display device 1. Additionally, a frame portion 206 is provided along the outer periphery of the liquid crystal display panel 202 in the display device 2. In this case, the frame portion 106 and the frame portion 206 are arranged to be at positions facing each other at the locations at which the display device 1 and the display device 2 face each other. Specifically, on the frame portion 106, the part of the frame portion 106 corresponding to the lower side of the liquid crystal panel 102 is arranged to face, on the frame portion 206, the part of the frame portion 206 corresponding to the upper side of the liquid crystal panel 202. Furthermore, in this case, on the frame portion 106 and the frame portion 206, the surfaces on the sides with the display screen of the liquid crystal panel 102 (or the liquid crystal panel 202) are at positions sandwiched between the liquid crystal panel 102 and the liquid crystal panel 202.

In this drawing, if a diagonal line from the upper edge of the screen to the lower edge is displayed when a video signal is displayed, then the diagonal line is displayed so as to extend from the upper edge of the liquid crystal panel 102 of the display device 1 towards the lower edge of the liquid crystal panel of the display device 2. In this case, the diagonal line is not displayed at the part with the frame portion 106 and the frame portion 206. This non-display part (reference number 401) will be further explained.

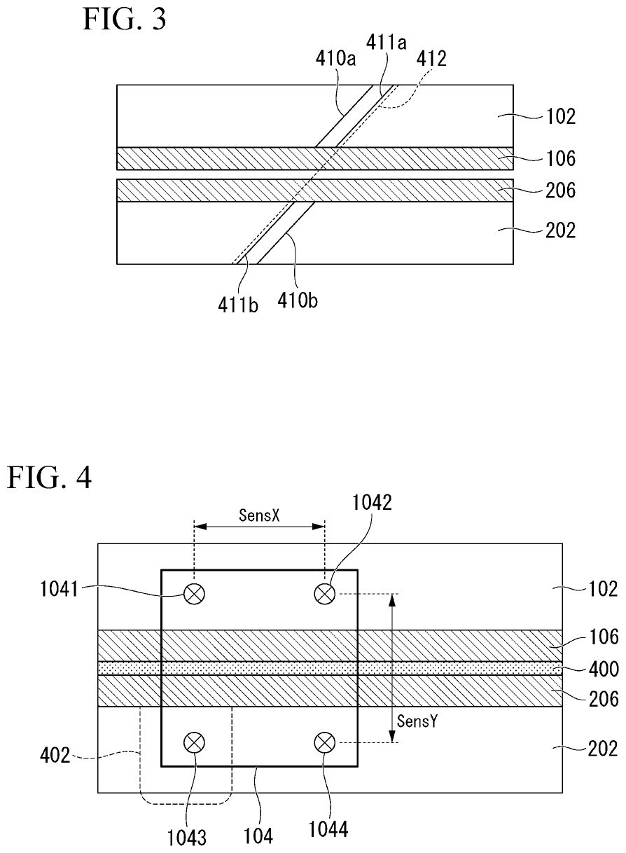

FIG. 3 is an enlarged view of part of the area forming the non-display part in FIG. 2.

If the video signal is divided and displayed without taking into account the parts that are not displayed due to the frame portion 106 and the frame portion 206, then as indicated by the straight line 410a and the straight line 410b, the straight lines will not be displayed so as to be aligned with each other, and will be displayed so as to be offset to different positions in the lateral direction.

Next, even if the parts that are not displayed due to the frame portion 106 and the frame portion 206 are taken into account so that the video signal is divided and processed on the basis of the distances of the frame portion 106 and the frame portion 206, there will be cases, as indicated by the straight line 411a and the straight line 411b, in which the straight line 411a and the straight line 411b are displayed so that the straight lines are not aligned with each other, and are displayed so as to be offset to different positions in the horizontal direction, though the offset amount will be less than that between the straight line 410a and the straight line 410b. This is caused by a gap that is formed at the part where the display device 1 and the display device 2 face each other. Although the sizes of the frame portion 106 and the frame portion 206 partially forming the non-display portion are known at the time of manufacture, the gap cannot be determined in advance.

In the present embodiment, by displaying the video signal while taking this gap into consideration, as indicated by the straight line 412, when a video signal is displayed on the display panel 102 and the display panel 202, the offset is reduced in the direction (the horizontal direction in this case) in which the edges of the liquid crystal panel 102 of the display device 1 and the liquid crystal panel 202 of the display device 2 face each other, so that the straight line displayed on the liquid crystal panel 102 and the straight line displayed on the liquid crystal panel 202 to be in a relationship of being on a straight line with each other, and the video signal is displayed in the ideal state indicated by the straight line 412. In this drawing, a portion of the straight line 412 is not actually displayed at the non-display portion, but is illustrated in the non-display portion in order to make it easier to understand that there is no offset.

Additionally, the offset mentioned above was explained for the case in which the display device 1 and the display device 2 are arranged in the vertical direction (longitudinal direction). However, even when the display device 1 and the display device 2 are arranged in the horizontal direction (lateral direction), and when a gap is formed between the frame portion 106 and the frame portion 206, there will be an offset in the vertical direction.

FIG. 4 is a drawing for explaining the relationship between the light detection sensor 104 and the display devices. This drawing illustrates the case in which the light detection sensor 104 is mounted near the non-display part (for example, the part indicated by reference number 401) in FIG. 2.

The light detection sensor 104 is provided with multiple regions that can detect light. In this case, an example in which the light detection sensor 104 has four regions that can detect light, namely, the light detection unit 1041, the light detection unit 1042, the light detection unit 1043 and the light detection unit 1044, will be explained.

The light detection sensor 104 is mounted so as to receive light from each of the liquid crystal panel 102 of the display device 1 and the liquid crystal panel 202 of the display device 2. In this case, the light detection sensor 104 is mounted so as to bridge the liquid crystal panel 102 and the liquid crystal panel 202.

In this case, the light detection unit 1041 and the light detection unit 1042 are mounted so as to face the display screen of the liquid crystal panel 102, and the light detection unit 1043 and the light detection unit 1044 are mounted so as to face the display screen of the liquid crystal panel 202.

In this case, the distance (SensX) between the light detection unit 1041 and the light detection unit 1042, and the distance between the light detection unit 1043 and the light detection unit 1044, are both predetermined and thus are both known. The distance between the light detection unit 1043 and the light detection unit 1044 may be the same as the distance SensX. Additionally, the distance between the light detection unit 1041 and the light detection unit 1043, and the distance (SensY) between the light detection unit 1042 and the light detection unit 1044, are both predetermined and thus are both known. The distance between the light detection unit 1041 and the light detection unit 1043 may be the same as the distance SensY.

The positional relationship is such that the direction in which the light detection unit 1041 and the light detection unit 1042 are arranged is parallel, or can be considered to be substantially parallel, to the direction in which the light detection unit 1043 and the light detection unit 1044 are aligned.

Additionally, the light detection unit 1041 and the light detection unit 1043 are mounted, with respect to the display device 1 and the display device 2, so as to be arranged in the direction in which the display device 1 and the display device 2 face each other (for example, the vertical direction), and the light detection unit 1042 and the light detection unit 1044 are mounted, with respect to the display device 1 and the display device 2, so as to be arranged in the direction in which the display device 1 and the display device 2 face each other (for example, the vertical direction).

The light detection unit 1041 and the light detection unit 1042 each detect light from the liquid crystal panel 102. The light detection unit 1043 and the light detection unit 1044 each detect light from the liquid crystal display panel 202.

As the light detection unit 1041, the light detection unit 1042, the light detection unit 1043 and the light detection unit 1044, it is possible to use physically independent detection elements. Alternatively, as these light detection units, it is possible to use an element, such as a CCD (solid-state imaging element), that detects light from video images (liquid crystal panels) by means of multiple pixels provided in a single sensor, in which case it is possible to use specific pixels (pixels at positions corresponding to the light detection unit 1041, the light detection unit 1042, the light detection unit 1043 and the light detection unit 1044) among the multiple pixels.

Here, the distances between the light detection units are determined by making the distances (SensZ) between the video display portions (liquid crystal panels) and the respective light detection units known.

In the light detection sensor 104, the distance SensY is set so that the frame portion 106, the frame portion 206, part of the liquid crystal panel 102 and part of the liquid crystal panel 202 are included. In this case, for example, the distance SensX and the distance SensY can be set so as to each be approximately 15 cm. The distance SensX and the distance SensY may be the same distance or may be different distances.

Next, the area near the part indicated by reference number 402 in this drawing will be further explained by using drawings.

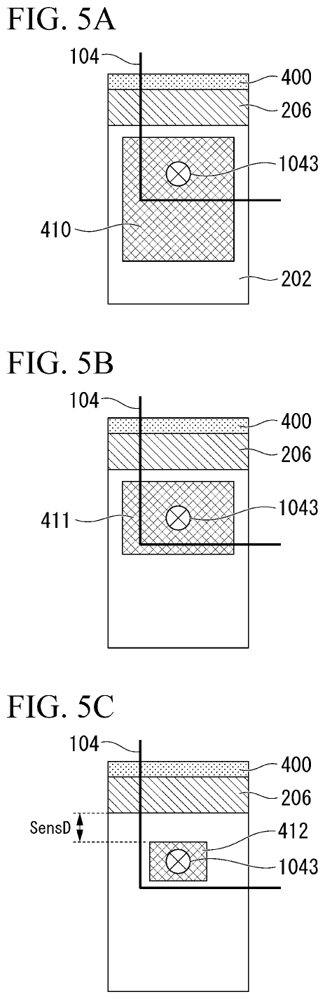

FIG. 5 is a drawing for explaining the relationship between the light detection unit and the position-detecting display pattern. In FIG. 5A, the position-detecting display pattern is a video signal that is displayed when using the light detection sensor 104 to adjust the positions of the display devices with respect to each other. Additionally, this position-detecting display pattern is displayed by the CPU 103 outputting instructions to display the position-detecting display pattern to the video processing circuit 101, thereby making the video processing circuit 101 display the position-detecting display pattern on the liquid crystal panel 102. Additionally, this position-detecting display pattern is displayed by the CPU 203 outputting instructions to display the position-detecting display pattern to the video processing circuit 201, thereby making the video processing circuit 201 display the position-detecting display pattern on the liquid crystal panel 202.

The video processing circuit 201 displays the position-detecting display pattern on the liquid crystal panel 202 while successively changing the position or size at which it is displayed. In this case, the video processing circuit 201 detects the position at which the light detection unit 1043 is installed on the liquid crystal panel 202 based on whether or not the light detection unit 1043 detects brightness, while reducing the the display range (display size) of the position-detecting display pattern. For example, among the detection results obtained from the light detection sensor 104, the CPU 203 refers to the detection results from the light detection unit 1043 and determines whether or not the light detection unit 1043 detects light. In this case, if the position-detecting display pattern is displayed at a position facing the light detection unit 1043, then the CPU 203 can obtain a detection result indicating that light has been detected from the light detection unit 1043, and if the position-detecting display pattern is not displayed at a position facing the light detection unit 1043, then a detection result indicating that light has been detected cannot be obtained from the light detection unit 1043, and a detection result indicating that light has not been detected is obtained from the light detection unit 1043.

On the basis of this detection result, if the light detection unit 1043 detects light, then the CPU 203 instructs the video processing circuit 201 to change the size of the position-detecting display pattern so as to be smaller. In accordance therewith, the video processing circuit 201 displays the position-detecting display pattern on the liquid crystal panel 202 at a reduced size. In this case, if the position-detecting display pattern is not detected by the light detection unit 1043, then the display position of the position-detecting display pattern is changed so that light can be detected by the light detection unit 1043. Furthermore, when the size of the position-detecting display pattern reaches a prescribed size, the position of a pixel in the liquid crystal panel 201 at which the position-detecting display pattern is displayed can be detected as the position of the light detection unit 1043. In this case, because the primary purpose is to detect the position of the light detection unit in the vertical direction relative to the display device 1 or the display device 2, it is preferable to change the vertical position or the vertical display size of the position-detecting display pattern in accordance with whether or not brightness was detected by the light detection unit.

In FIG. 5A, the position-detecting display pattern 410 is displayed at a position on the liquid crystal panel 201 facing the light detection unit 1043, so the light detection unit 1043 detects light. Based on this detection result, the CPU 203 instructs the video processing circuit 201 to make the size of the position-detecting display pattern smaller. For example, the CPU 203 designates the pixels (one or multiple pixels) to be displayed on the screen of the liquid crystal panel 201, in which the display region of the position-detecting display pattern is to be displayed. The video processing circuit 201 makes the designated pixels display the position-detecting display pattern.

In this way, the CPU 203 changes the size of the position-detecting display pattern and the display position thereof on the liquid panel 201 until the display size of the position-detecting display pattern becomes a prescribed size (FIG. 5B and FIG. 5C).

Furthermore, when the size of the position-detecting display pattern has become the prescribed size, the CPU 203 can determine the distance (SensD) from the central position in the display of the position-detecting display pattern to the outer periphery of the liquid crystal panel 201 (the edge of the liquid crystal panel 201) in the position-detected display pattern. In this case, the CPU 203 can determine the distance SensD from the central position in the display of the position-detecting display pattern to the edge of the liquid crystal panel 201 facing the frame 206 on which the light detection sensor 104 is provided. By determining this distance SensD, the positions of the light detection units in the vertical direction (longitudinal direction) of the display device 1 or the display device 2 can be detected.

Next, in the state in which the light detection sensor 104 is installed with respect to the display device 1 and the display device 2, the case in which the range that can be detected by the light detection units is approximately a single display pixel or smaller (case 1) and the case in which the range includes multiple display pixels (case 2) will be explained below.

### Case 1

If the range that can be detected by the light detection units in the light detection sensor 104 is approximately a single display pixel or smaller, then the size of the position-detecting display pattern is made approximately the same as a single display pixel, and without changing the size of this position-detecting display pattern, the position at which it is displayed on the liquid crystal display panel is moved in the longitudinal direction and the lateral direction, and the position of the pixel when the light was able to be detected by the light detection unit is detected as the position of the light detection unit. In this case, the position of the light detection unit is identified by the brightness of the display pixel. For example, if the light detection unit and the one pixel at which the position-detecting display pattern is displayed are at positions facing each other, then the light will be detected by the light detection unit, thereby allowing the position of that pixel to be detected as the position of the light detection unit.

### Case 2

If the range that can be detected by the light detection unit includes multiple display pixels, in other words, if the size of the range over which the light from the light detection unit can be detected is a size that can include a range covering multiple adjacent pixels, then either (a) or (b) below is executed.

(a) As the position-detecting display pattern, a position-detecting display pattern that lights approximately a single pixel is used, and this position-detecting display pattern is moved in the longitudinal direction or the lateral direction over the display screen of the liquid crystal panel. Then, the position of the pixel when the light was detected by the light detection unit is detected as the position of the light detection unit. In this case, the pixel for which the brightness of the light detected by the light detection unit is the brightest is detected as the position of the light detection unit.
(b) As the position-detecting display pattern, a position-detecting display pattern that lights multiple adjacent pixels is used, and at least one of moving this position-detecting display pattern in the longitudinal direction or the lateral direction, and changing the size of this position-detecting display pattern, is performed. Then, the position at which the position-detecting display pattern was displayed when the light was able to be detected by the light detection unit is identified by the brightness of the detected light. The position of the light detection unit can be identified by identifying the positions of the pixels at which the brightness of the light was detected. For example, even if the position of the position-detecting display pattern is changed, the position of the light detection unit can be detected by determining, for example, the central position among the pixels, based on each of the positions at which at least a certain level of brightness of light was detected by the light detection unit.

Additionally, in case 2, for example, when the position-detecting display pattern is a position-detecting display pattern that lights approximately one pixel, if the change in the detected values by the light detection units due to moving the position-detecting display pattern in the longitudinal direction or the lateral direction can be sufficiently obtained, then the results obtained by the process in the above-mentioned case (a) are used. However, if that is not the case, then the results obtained by the process in the above-mentioned case (b) are used.

The CPU 203 can determine the distance across a non-display part when the positions of the light detection units are detected.

For example, since the distance between the light detection sensor 1041 and the light detection unit 1043 is known, the CPU 203 can determine the distance across the non-display part between the light detection sensor 1041 and the light detection unit 1043 by subtracting, from the distance between the light detection sensor 1041 and the light detection unit 1043, the length (distance (SensD3)) from the central position of the display of the position-detecting display pattern detected by the light detection unit 1043 to the outer periphery (edge) of the liquid crystal panel 201, and the length (distance (SensD1)) from the central position of the display of the position-detecting display pattern detected by the light detection sensor 1041 to the outer periphery (edge) of the liquid crystal panel 101. Furthermore, by subtracting the width of the frame portion 106 and the width of the frame portion 206 from the distance across the non-display part, the CPU 203 can determine the distance across the gap in the non-display part.

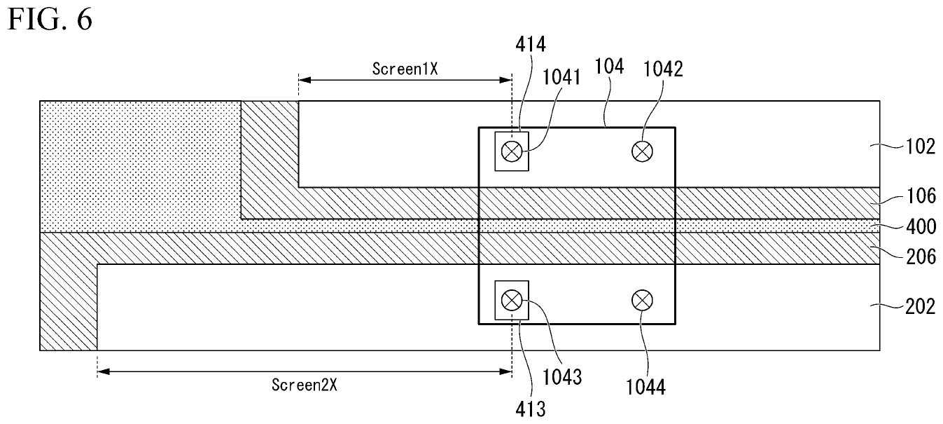

Next, horizontal position detection in the display device will be explained using FIG. 6.

When the above-mentioned position-detecting display pattern is displayed, it can be used not only to detect the position in the vertical direction, but also when detecting the positions of the light detection units in the horizontal direction. Additionally, the position of this position-detecting display pattern is designated by the CPU 203 (CPU 103) not only in the vertical direction, but also in the horizontal direction when displaying the position-detecting display pattern, and the position is thus known.

For this reason, the CPU 203 (CPU 103) performs at least one of changing the position of the position-detecting display pattern in the horizontal direction and changing the size of the position-detecting display pattern in the horizontal direction, and detects brightness by means of the light detection units until the size of the position-detecting display pattern becomes a prescribed size. Furthermore, when the position-detecting display pattern has become the prescribed size, the positions of the light detection units in the horizontal direction can be determined by determining the distances (Screen1X, Screen2X) from the positions of the light detection units detected on the basis of the position-detecting display pattern to the edge of the liquid crystal panel 201 (liquid crystal panel 101) in the horizontal direction.

In this case, the CPU 103 detects the position of the light detection unit 1041 by changing the display position or the display size of the position-detecting display pattern 414. The CPU 203 detects the position of the light detection unit 1043 by changing the display position or the display size of the position-detecting display pattern 413.

The above-described detection of the positions of the light detection units in the vertical direction and the detection of the positions of the light detection units in the horizontal direction are performed for both the display device 1 and the display device 2.

Next, the procedure for detecting whether the display device 1 and the display device 2 are installed parallel to each other will be explained.

When the light detection sensor 104 is mounted on the display device 1 and the display device 2, the lengths from the light detection units to the edges on the outer peripheries of the liquid crystal panels can be detected by installing the light detection units perpendicularly with respect to the contacting parts (in the direction of the sides facing each other) of the two display devices. In order to do so, it is necessary to install two light detection units on the display surfaces of the liquid crystal panels and to check whether the the display devices are installed parallel to each other.

FIG. 7 is a drawing showing the state in which two display devices (display device 1, display device 2) are installed parallel to each other, and the light detection sensor 104 is mounted so as to be perpendicular to the directions of the sides corresponding to the display device 1 and the display device 2 on the display surface near the frame portions (frame portion 106, frame portion 206) at which the display device 1 and the display device 2 face each other. In this way, it is preferable for the display device 1 and the display device 2 to be installed parallel to each other at the parts at which they face each other. However, depending on the installation environment, there may be cases in which they cannot always be made parallel. Here, the case in which it is checked whether or not the two display devices are installed parallel to each other will be explained.

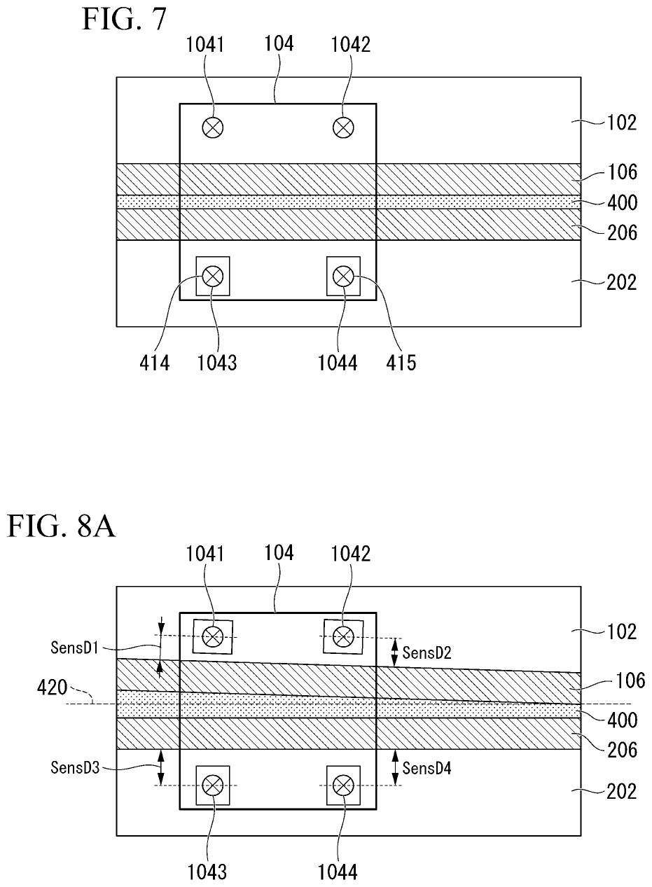

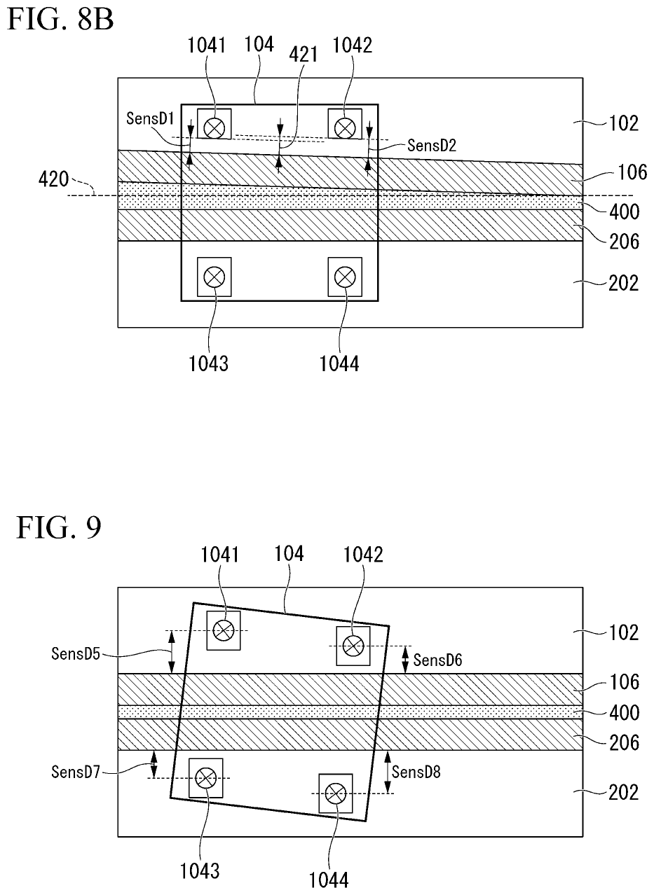

FIG. 8 shows diagrams for explaining the state in which two display devices are not installed parallel to each other. In FIG. 8A, the distance SensD3 from the light detection unit 1043 to the edge of the liquid crystal panel 202 (the part facing the frame portion 206) is equal to the distance SensD4 from the light detection unit 1044 to the edge of the liquid crystal panel 202 (the part facing the frame 206). Thus, it can be understood that the direction of alignment of the light detection unit 1043 and the light detection unit 1044 is parallel to the length direction of the edge of the liquid crystal panel 202.

On the other hand, the distance SensD1 from the light detection unit 1041 to the edge of the liquid crystal panel 102 (the part facing the frame portion 106) is not equal to the distance SensD2 from the light detection unit 1042 to the edge of the liquid crystal panel 102 (the part facing the frame 106). Thus, it can be understood that the direction of alignment of the light detection unit 1041 and the light detection unit 1042 is not parallel to the length direction of the edge of the liquid crystal panel 102. In this case, it can also be understood that the frame portion 206 and the frame portion 106 are not parallel because the frame portion 106 is tilted with respect to the line 420, which is parallel to the frame portion 206.

For this reason, adjustments are made so that the direction of alignment of the two light detection units provided with respect to a liquid crystal panel of a display device that has been set as a master device is parallel to the length direction of the edge of that liquid crystal panel. After doing so, in a display device that has been set as a subsidiary device, as illustrated in FIG. 8B, the length midpoint from the positions of the two light detection units to the edge of the display surface is taken. In this case, the distance SensD1 is shorter than the distance SensD2. In this case, the distance from the midpoint (reference number 421) between the light detection sensor 1041 and the light detection sensor 1042 to the edge of the liquid crystal panel 102 is detected, and this distance is used.

In an embodiment to be described below, when connected to a PC, there is no priority, but the midpoint is applied to those in which the sensors cannot be installed in the parallel state.

If the direction along the edge of the liquid crystal panel 202 is parallel to the direction of alignment of the light detection unit 1043 and the light detection unit 1044, and the direction along the edge of the liquid crystal panel 102 is not parallel to the direction of alignment of the light detection unit 1041 and the light detection unit 1042, then the midpoint can be used, but it is also possible to use any position between the light detection unit 1041 and the light detection unit 1042 as the position for determining the distance to the edge of the liquid crystal panel 102. In this case, it is preferable to use the midpoint between the light detection sensor 1041 and the light detection sensor 1042 because there is less error in the distance of the gap.

Next, the case in which the length direction of the edge of the liquid crystal panel 102 is not parallel to the direction of alignment of the light detection unit 1041 and the light detection unit 1042, and the length direction of the edge of the liquid crystal panel 202 is not parallel to the direction of alignment of the light detection unit 1043 and the light detection unit 1044 will be explained.

FIG. 9 is a diagram representing the case in which the length direction of the edge of the liquid crystal panel 102 is not parallel to the direction of alignment of the light detection unit 1041 and the light detection unit 1042, and the length direction of the edge of the liquid crystal panel 202 is not parallel to the direction of alignment of the light detection unit 1043 and the light detection unit 1044. In other words, this is a case in which the light detection sensor 104 is not installed so as to be perpendicular to the direction of the sides on which the two display devices face each other.

In this case, the distance SensD5 from the light detection sensor 1042 to the edge of the liquid crystal panel 102 is not equal to the distance SensD6 from the light detection sensor 1041 to the edge of the liquid crystal panel 102. Thus, it can be understood that the length direction of the edge of the liquid crystal panel 102 is not parallel to the direction of alignment of the light detections sensor 1041 and the light detection sensor 1042.

Additionally, the distance SensD7 from the light detection sensor 1043 to the edge of the liquid crystal panel 202 is not equal to the distance SensD8 from the light detection sensor 1044 to the edge of liquid crystal panel 202. Thus, it can be understood that the length direction of the edge of the liquid crystal panel 102 is not parallel to the direction of alignment of the light detection sensor 1043 and the light detection sensor 1044.

In this case, it can be understood that the two video display devices are installed parallel to each other when the difference in length between the distance SensD5 and the distance SensD6 is equal to the difference in length between the distance SensD7 and the distance SensD8. In such a case, the installation position of the light detection sensor 104 relative to the two display devices is adjusted so as to be parallel to the length direction of the edges of the liquid crystal panels, and it is checked that they were installed is parallel.

On the other hand, it can be understood that the two video display devices are not installed parallel to each other when the difference in length between the distance SensD5 and the distance SensD6 is not equal to the difference in length between the distance SensD7 and the distance SensD8. In such a case, the position of the light detection sensor 104 is adjusted so that, of the two display devices, the positioning of one of the display devices is parallel to that of the light detection sensor 104, and the distance from the above-mentioned midpoint is determined.

Furthermore, after the position of the light detection sensor 104 with respect to the two video display devices has been set, the lengths to the edges of the liquid crystal panels are determined.

The length from a light detection unit to the edge of a liquid crystal panel is computed by using the equation indicated below:

Length from light detection unit to edge of liquid crystal panel=Position of central coordinate of position-detecting display pattern with reference to edge of liquid crystal panel×Size of display pixel

In this case, the distances between the light detection units (the distance between the light detection unit 1041 and the light detection unit 1043, the distance between the light detection unit 1042 and the light detection unit 1044) are known, and the gaps formed at warping of the outer periphery or the joint portions of the display devices can be measured by subtracting the lengths to the edges of the display surfaces of the two screens from the distances between the light detection units.

Furthermore, under conditions in which the same video signal is divided and displayed, the distances computed in the above-described manner are used to determine the division positions, and the divided images are displayed in an enlarged or reduced manner. As a result thereof, it is possible to reduce the offset when displaying diagonal lines and the like.

This measurement can also be made by fixing a sensor to the display device that is to serve as the master device, and measuring the distance from the display that is to serve as the subsidiary device. However, in that case, the display surface is covered, thereby decreasing the display range. Additionally, it is also possible to measure the distance on the rear side of the display surface, but this cannot account for offsets occurring between the rear surface and the display surface, so it is desirable to measure the display surface.

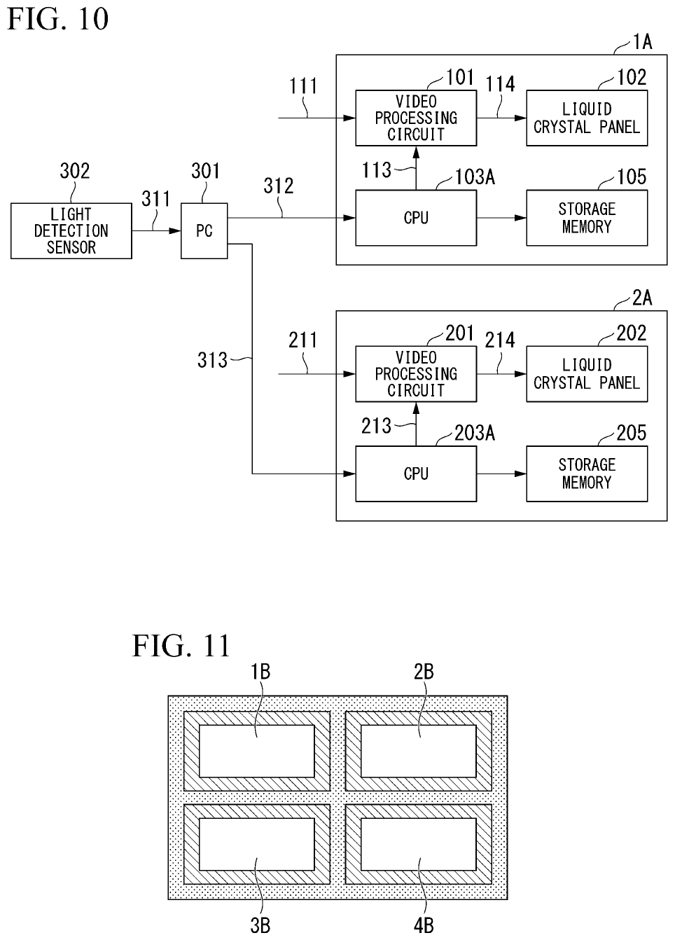

FIG. 10 is a block diagram showing the structure of a display device 1A according to a second embodiment.

In this case, the display device 1A and the display device 2A have functions similar to the display device 1 and the display device 2 in the above-mentioned first embodiment. Here, the explanations of the similar functions will be omitted, and the different functions will be explained.

In this second embodiment, the light detection sensor 302 has the same function as the light detection sensor 104, but is not connected to the display device, but rather to a computer (PC) 301. The light detection sensor 302 outputs the detection results, as a light sensor detection signal 311, to the PC 302.

The PC 301 has the function of acquiring a light sensor detection signal 311 from the light detection sensor 302. Additionally, the PC 301 controls a CPU 103A by outputting a video display device control signal 312 to the CPU 103A. Additionally, the PC 301 controls a CPU 203A by outputting a video display device control signal 313 to the CPU 203A.

In the first embodiment, either the display device 1 or the display device 2 served as a master device and the remaining display device served as a subsidiary device to perform position detection. However, this second embodiment is controlled by the PC 301, so it is not always necessary to set a master device and a subsidiary device.

Next, the case in which position detection is performed in a display system formed from four display devices will be explained.

FIG. 11 is a drawing representing the arrangement state of the display system formed from four display devices. Here, the case in which the display devices are arranged so that there are two in the longitudinal direction and two in the lateral direction, with the display device 1B at the upper left, the display device 2B at the upper right, the display device 3B at the lower left and the display device 4B at the lower right will be explained. In this case, the display device 3B is adjacent to the display device 1B on the lower side thereof, the display device 2B is adjacent to the display device 1B on the right side thereof, and the display device 4 is adjacent to the display device 2B and the display device 3B.

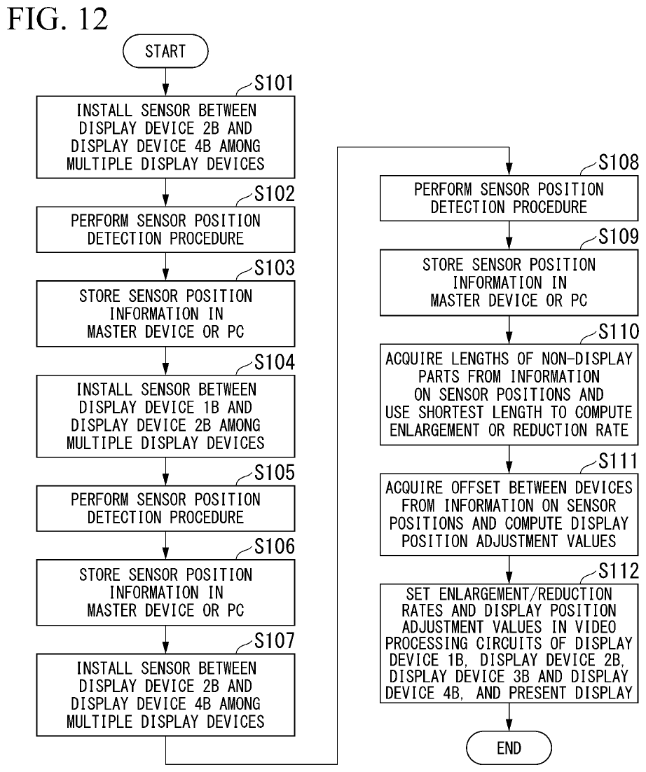

FIG. 12 is a flow chart for explaining the operations for detecting the position in a display system formed from four display devices.

First, among the multiple display devices, a light detection sensor 104 is installed so as to bridge the display device 2B and the display device 4B (step S101). Then, position detection is performed based on the detection results from the light detection sensor 104 (step S102). This position detection involves detecting the positions, on the liquid crystal panels, of each of the light detection sensor 1041, the light detection sensor 1042, the light detection sensor 1043 and the light detection sensor 1044, as explained in the first embodiment. For example, the positions of the light detection sensor 1041 and the light detection sensor 1042 on the liquid crystal panel of the display device 2B, and the positions of the light detection sensor 1043 and the light detection sensor 1044 on the liquid crystal panel of the display device 4B are detected.

Additionally, in this case, if the display device 1B is a master device, then the CPU of the display device 1B outputs a display device inter-device control signal to the display device 2B and the display device 4B, thus making the display device 2B and the display device 4B respectively display position-detecting display patterns, and acquiring detection results from the light detection sensor 104. Furthermore, the CPU in the display device 1B detects the positions of the light detection units on the light detection sensor 104 based on detection results from the light detection sensor when the position-detecting display pattern has become a prescribed size.

The CPU of the display device 1B stores information representing the detected position in a storage memory in the display device 1B (step S103). When a PC is used as in the second embodiment, the PC stores the information representing the detected position in a storage memory in the PC.

Next, the light detection sensor 104 is installed so as to bridge the display device 1B and the display device 2B (step S104). Then, the CPU of the display device 1B displays the position-detecting display pattern on each of the display device 1B and the display device 2B, and performs position detection based on the detection results from the light detection sensor 104 (step S105). In this case, for example, the positions of the light detection sensor 1041 and the light detection sensor 1042 on the liquid crystal panel of the display device 1B, and the positions of the light detection sensor 1043 and the light detection sensor 1044 on the liquid crystal panel of the display device 2B are detected. Then, the CPU of the display device 1B stores information representing the detected position in the storage memory in the display device 1B (step S106). When a PC is used as in the second embodiment, the PC stores the information representing the detected position in a storage memory in the PC.

Next, the light detection sensor 104 is installed so as to bridge the display device 2B and the display device 4B (step S107). Then, the CPU of the display device 1B displays the position-detecting display pattern on each of the display device 2B and the display device 4B, and performs position detection based on the detection results from the light detection sensor 104 (step S108). In this case, for example, the positions of the light detection sensor 1041 and the light detection sensor 1042 on the liquid crystal panel of the display device 2B, and the positions of the light detection sensor 1043 and the light detection sensor 1044 on the liquid crystal panel of the display device 4B are detected. Then, the CPU of the display device 1B stores information representing the detected position in the storage memory in the display device 1B (step S109). When a PC is used as in the second embodiment, the PC stores the information representing the detected position in a storage memory in the PC.

Next, the CPU of the display device 1B divides a video signal so as to correspond to the four screens, and allocates the divided screens to the corresponding display devices among the four display devices. Then, the CPU in the display device 1B computes the lengths of the non-display parts based on the position information for the respective display devices stored in the storage memory, and uses the shortest length to compute an enlargement rate or a reduction rate (step S110).

Next, the CPU of the display device 1B acquires the offset between the display devices based on the positions of the respective light detection units, and computes adjustment values for the display positions in the video signal (step S111).

Next, the CPU of the display device 1B transmits the enlargement/reduction rates and the display position adjustment values to the video processing circuits of each of the display device 1B, the display device 2B, the display device 3B and the display device 4B. The video processing circuits that have acquired these information enlarge or reduce the divided screens allocated thereto among the video signal on the basis of these enlargement/reduction rates and display position adjustment values, determine, in accordance with the display position adjustment values, the ranges of the divided screens that are to be displayed, and display the images on the liquid crystal panels (step S112).

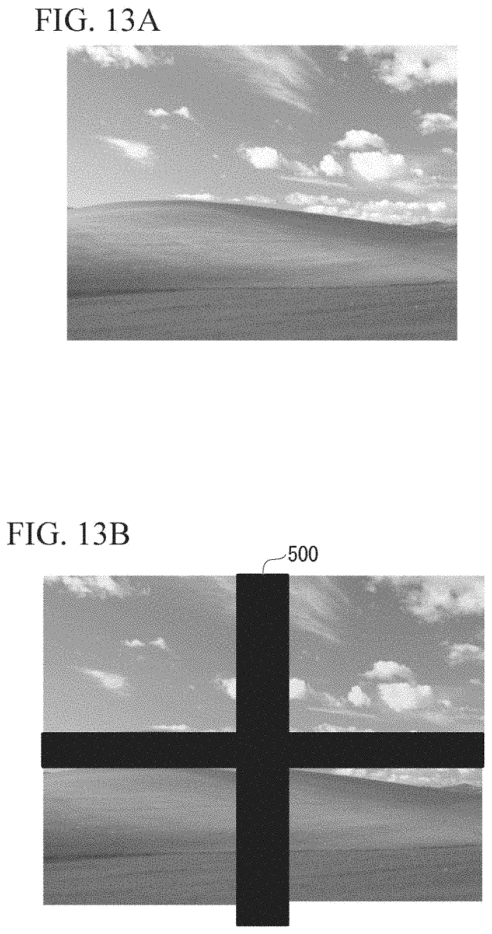

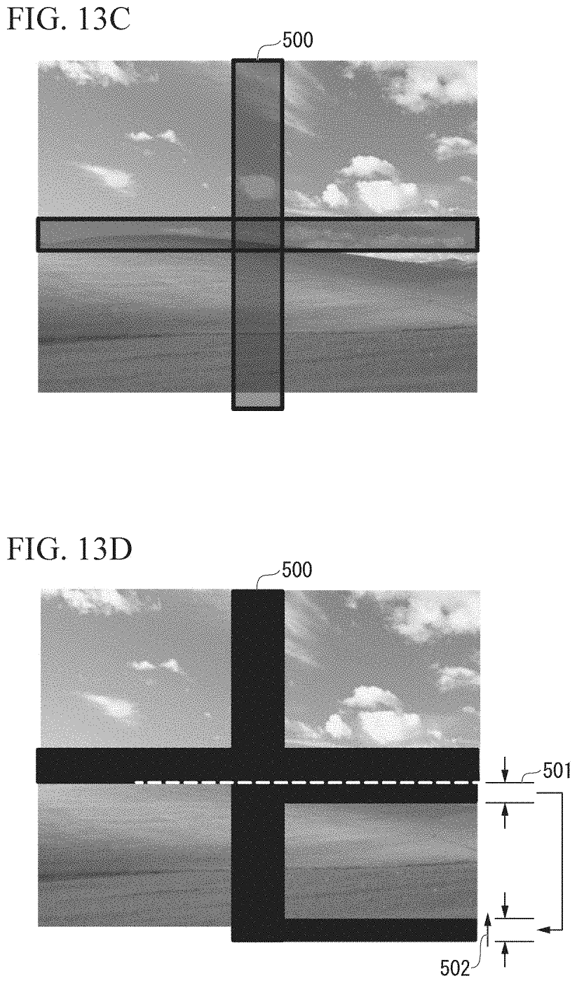

FIG. 13 is a drawing for explaining the case in which the above-mentioned four display devices display a video signal using position information from the light detection units. FIG. 13A is a drawing representing a video signal to be displayed. The case in which such a video signal is displayed on a display system by being simply divided into quarters so as to be displayed on four display devices is illustrated in FIG. 13B. In this case, the frame portions of the display devices and the gaps therebetween exist as a non-display part 500 between the divided images. In this case, there is an offset in the display content of the divided screens at the non-display part 500, so a sense of discomfort occurs in a connection of the video signals with the non-display part 500 as a boundary. In this case, even if there is a non-display part 500 as illustrated in FIG. 13C, it is possible to reduce the sense that the video signal does not fit together properly at the non-display part 500 by reducing the offset in the display content of the divided screens.

In this case, as illustrated in FIG. 13D, for example, if the arrangement position of the display device arranged at the lower right is such as to be installed in a state in which there is a gap with respect to the display device on the upper right, then the display device on the lower right will be provided at a position that is offset with respect to the other display devices. In this case, the above-described position detection processes are performed, and the enlargement rates and the reduction rates or the display ranges of the display regions of the divided screens are determined by taking into consideration the distance across the non-display part including the gap. Here, the divided screen is moved from the lower side upwards (reference number 502) by the distance 501 corresponding to the gap. As a result thereof, for the divided screen in the lower-right display device, the display position in the horizontal direction matches the display position in the horizontal direction on the divided screen in the lower-left display device. Thus, even if there is a gap, the sense of not fitting properly can be reduced in the displayed video signal.

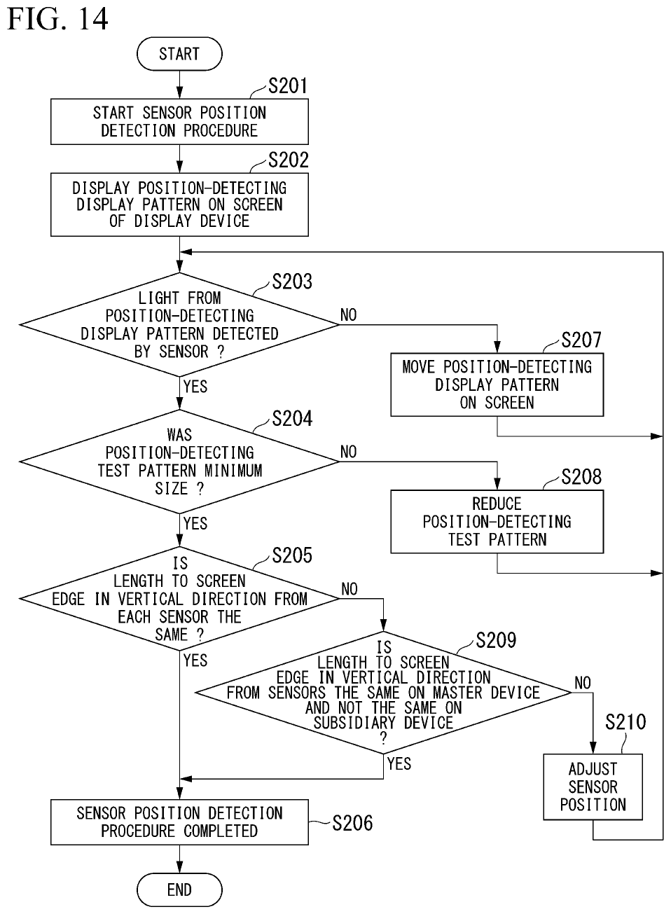

FIG. 14 is a flow chart for explaining the position detection process performed by the display device that is the master device or by a PC. Here, the case in which the display device that is the master device performs the process will be explained. However, it is also possible for a PC to perform the process in accordance with a similar procedure.

First, when the position detection process of the light detection sensor 104 is started (step S201), the CPU of the display device instructs a display device on which the light detection sensor 104 is mounted to display the position-detecting display pattern. The display device that has received this instruction displays a position-detecting display pattern on the liquid crystal panel (step S202).

The CPU of the display device that is the master device acquires the detection results from the light detection sensor 104 at this time, and determines whether or not the light from the position-detecting display pattern was detected by the light detection sensor 104 (step S203). If light was not detected, then the CPU of the display device that is the master device instructs the display device that is being controlled to move the position-detecting display pattern on the screen of the liquid crystal panel (step S207). As a result thereof, the position at which the position-detecting display pattern is displayed on the screen of the display device that is being controlled is changed, and thereafter, the procedure shifts to step S203.

In step S203, if light is detected by the light detection sensor 104, the CPU of the display device that is the master device determines whether or not the display size of the position-detecting display pattern is a prescribed size (for example, a minimum size) (step S204). If the display size of the position-detecting display pattern is not the minimum size, then the CPU of the display device that is the master device displays the position-detecting display pattern with the display size reduced from the current size (step S208). As a result thereof, on the screen of the display device that is being controlled, the display size at which the position-detecting display pattern is displayed is reduced, and thereafter, the procedure shifts to step S203.

Next, when the display size of the position-detecting display pattern becomes the minimum size, the CPU of the display device that is the master device shifts to the process in step S205. In this step, it is determined whether or not the lengths from the respective light detection units to the screen edges (edges of the liquid crystal panels) in the vertical direction are the same (step S205). If the lengths are the same, then the CPU of the display device that is the master device ends the detection process for the sensor position at the mounting position of that light detection sensor 104.

However, if the lengths from the respective light detection units to the screen edges (edges of the liquid crystal panels) in the vertical direction are not the same, then the CPU of the display device that is the master device determines whether or not the two light detection units that are mounted so as to face the master device have lengths to the screen edge that are the same in the direction perpendicular to the side of the frame portion, and whether or not the two light detection units that are mounted so as to face the subsidiary device have lengths to the screen edge that are the same in the direction perpendicular to the side of the frame portion (step S209).

If the two light detection units that are mounted so as to face the master device have lengths to the screen edge that are the same in the direction perpendicular to the side of the frame portion, and the two light detection units that are mounted so as to face the subsidiary device have lengths to the screen edge that are not the same in the direction perpendicular to the side of the frame portion, then the CPU of the display device that is the master device shifts to step S206. On the other hand, if the state is not such that the two light detection units that are mounted so as to face the master device have lengths to the screen edge that are the same in the direction perpendicular to the side of the frame portion, and the two light detection units that are mounted so as to face the subsidiary device have lengths to the screen edge that are not the same in the direction perpendicular to the side of the frame portion, then the CPU in the display device that is the master device displays a message, indicating that the mounting position of the light detection sensor 104 should be adjusted, for a certain period of time on the display device that is the master device (step S210). Based on this message, a user adjusts the position of the light detection sensor 104. Thereafter, the process is executed from step S203.

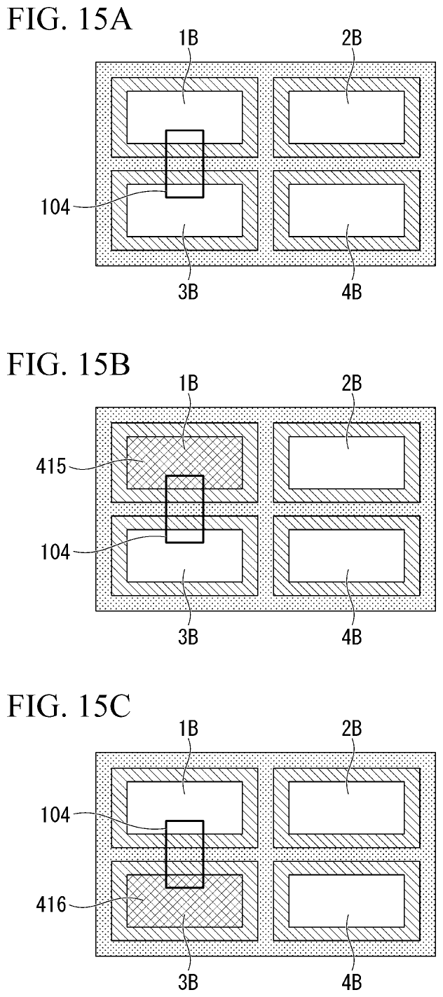

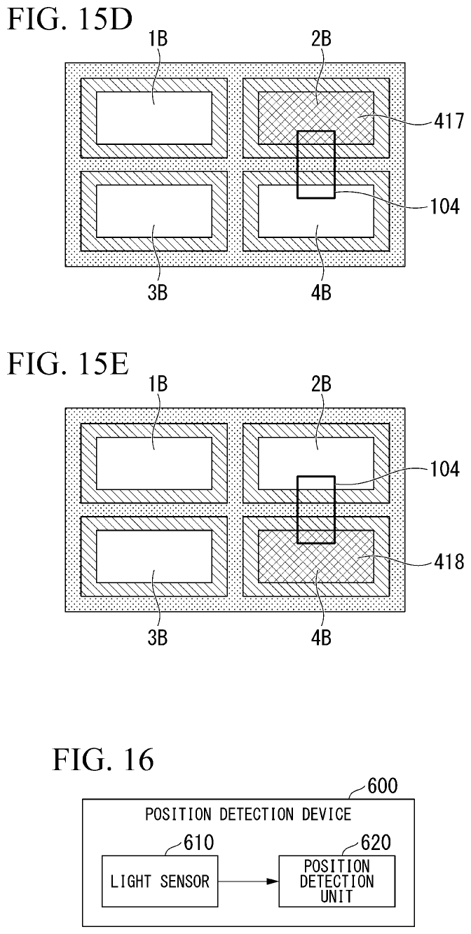

FIG. 15 is a drawing representing the case in which a display system is formed from four display devices. In this case, as illustrated in FIG. 15A, the display device 1B is installed on the upper left, the display device 2B is installed on the upper right, the display device 3B is installed on the lower left, and the display device 4B is installed on the lower right. Furthermore, the light detection sensor 104 is mounted so as to bridge the display device 1B and the display device 3B.

After the light detection sensor 104 is mounted so as to bridge the display device 1B and the display device 3B as illustrated in FIG. 15B, the position-detecting display pattern is displayed on either one of the display devices. Then, when light is detected by any of the light detection units on the light detection sensor 104, it can be detected that the light detection unit is mounted on the display device on which the position-detecting display pattern is displayed.

For example, light is detected by the light detection sensor 104 when a position-detecting display pattern 415 is displayed on the display device 1B, as illustrated in FIG. 15B, and light is detected by the light detection sensor 104 when a position-detecting display pattern 416 is displayed on the display device 3B, as illustrated in FIG. 15C. As a result thereof, it can be detected that the light detection sensor 104 is mounted so as to bridge the display device 1B and the display device 3B.

Then, position detection is performed in the display device 1B and the display device 3B. Then, after mounting the light detection sensor 104 so as to bridge the display device 2B and the display device 4B as illustrated in FIG. 15D, position detection is performed by displaying the position-detecting display pattern 417 on the display device 2B. Thereafter, a position-detecting display pattern 418 is displayed on the display device 4B, as illustrated in FIG. 15E, and position detection is performed in the display device 4B.

Using these results, the installation positions in the vertical direction are adjusted for each display device.

Thereafter, position detection is performed with the light detection sensor 104 mounted so as to bridge the display device 1B and the display device 2B, and position detection is performed with the light detection sensor 104 mounted so as to bridge the display device 3B and the display device 4B. Using these position detection results, the installation positions in the horizontal direction are adjusted for each display device.

Next, a third embodiment will be explained.

FIG. 16 is a drawing illustrating the structure of a position detection device 600 in the third embodiment.

The position detection device 600 has a light sensor 610 and a position detection unit 620.

The light sensor 610 has a first light detection unit and a second light detection unit for detecting light from pixels, and is provided such that the first light detection unit is located at a position facing the display screen of the first display device and the second light detection unit is located at a position facing the display screen of the second display device that is provided adjacent to the first display device.

The position detection unit 620 detects the distance across a non-display region between the display screen of the first display device and the display screen of the second display device based on the results of detection, by the first light detection unit, of a position adjustment image displayed on the display screen of the first display device, the results of detection, by the second light detection unit, of a position adjustment image displayed on the display screen of the second display device, and the display content of the position adjustment images.

A position detection device 600 of this this type can, for example, be used by being connected to the display devices, a PC or the like. In particular, the positional relationship between the display devices in the multi-display system can be detected. As a result thereof, the positions at which the display devices are arranged can be adjusted on the basis of the detected positions, and a video signal to be displayed on each display device can be displayed with adjustments.

When a single image is to be displayed in a state in which multiple display devices are installed in an arrayed manner, by using sensors to measure the gaps formed during installation, enlargement and reduction corrections can be performed, thereby reducing the differences from a single image.

Additionally, a program for performing the functions of the CPU or the video processing circuit in the display device in FIG. 1 may be recorded on a computer-readable recording medium, and position detection may be performed by reading the program recorded on this recording medium into a computer system and executing the program. The “computer system” in this case includes an OS and hardware such as peripheral devices.

Additionally, if the “computer system” uses a www-based system, then it includes a webpage-presenting environment (or a display environment).

Additionally, the “computer-readable recording medium” refers to portable media such as flexible disks, magneto-optic disks, ROMs and CD-ROMs, and storage devices, such as hard disks, contained in computer systems. Furthermore, the “computer-readable recording medium” includes those that hold the program for a certain time, such as volatile memory inside a computer system serving as a server or a client. Additionally, the above-mentioned program may be for executing just some of the aforementioned functions, and furthermore, the aforementioned functions may be executed in combination with a program that is already recorded in a computer system. Additionally, the above-mentioned program may be stored on a prescribed server, and said program may be distributed (downloaded or the like) through a communication line in response to requests from other devices.

While embodiments of the present invention have been explained in detail with reference to the drawings above, the specific structure is not limited to these embodiments, and designs or the like not departing from the spirit of this invention are also included.

### REFERENCE SIGNS LIST

1, 2, 1A, 2A, 1B, 2B, 3B, 4B Display device
101, 201 Video processing circuit
102, 202 Liquid crystal display panel
103, 203, 103A, 203A CPU (central processing device)
104, 302 Light detection sensor
105, 205 Storage memory
111, 112 Video signal
115 Light sensor detection signal
106, 206 Frame portion
301 PC (computer)
410, 411, 412, 413, 414, 415, 416, 417 Position-detecting display pattern
1041, 1042, 1043, 1044 Light detection unit
600 Position detection device
610 Light sensor
620 Position detection unit

1. A position detection device for a display device, the position detection device comprising:
a light sensor including a first light detection unit and a second light detection unit that detect light from pixels, provided such that the first light detection unit is located at a position facing a display screen on a first display device, and the second light detection unit is located at a position facing a display screen on a second display device that is provided adjacent to the first display device; and
a processor configured to detect a distance across a non-display region between the display screen of the first display device and the display screen of the second display device based on results of detection, by the first light detection unit, of a position adjustment image displayed on the display screen of the first display device, results of detection, by the second light detection unit, of a position adjustment image displayed on the display screen of the second display device, and display content of the position adjustment images.

2. The position detection device according to claim 1, wherein:
the first light detection unit includes a first detection region and a second detection region, and the second light detection unit includes a third detection region and a fourth detection region arranged at positions parallel to a direction of alignment of the first detection region and the second detection region;
the first detection region and the third detection region are arranged, and the second region and the fourth region are arranged, in a direction in which the first display device and the second display device face each other; and
the processor detects the distance across the non-display region based on a relationship between a distance determined by detection results from the first detection region and detection results from the third detection region, and a distance determined by detection results from the second detection region and detection results from the fourth detection region.

3. The position detection device according to claim 2, wherein:
when a detection range of at least one detection region among the first to fourth detection regions is a range being capable of including multiple pixels on the display screen, the processor determines the position of a detection region that has detected light based on a level of brightness of light when the position adjustment image is detected.

4. The position detection device according to claim 2, wherein:
when a direction along an edge of the display screen of the first display device is parallel to the direction of alignment of the first detection region and the second detection region, and a direction along an edge of the display screen of the second display device is non-parallel to the direction of alignment of the third detection region and the fourth detection region, any position between the third detection region and the fourth detection region is used as a position for determining a distance to the edge of the display screen of the second display device.

5. The position detection device according to claim 1, wherein:
the position detection unit processor detects the distance across the non-display region by subtracting,
from a distance between the first detection region and the third detection region,
a distance from the first detection region to the edge of the display screen of the first display device,
a distance from the third detection region to the edge of the display screen of the second display device, and
a first frame portion distance that is a distance across a frame portion on the side having the display screen of the first display device, and a second frame portion distance that is a distance cross a frame portion on the side having the display screen of the second display device.

6. The position detection device according to claim 1, wherein:
the position adjustment image comprises an image in a successive display of images in which a display position on the displaying display screen is different or images in which a display size is different.

7. A display device comprising a position detection device according to, wherein positions of the display device itself and another display device adjacent to the display device are detected, and
the position detection device comprises:
a light sensor including a first light detection unit and a second light detection unit that detect light from pixels, provided such that the first light detection unit is located at a position facing a display screen on a first display device, and the second light detection unit is located at a position facing a display screen on a second display device that is provided adjacent to the first display device; and
a processor configured to detect a distance across a non-display region between the display screen of the first display device and the display screen of the second display device based on results of detection, by the first light detection unit, of a position adjustment image displayed on the display screen of the first display device, results of detection, by the second light detection unit, of a position adjustment image displayed on the display screen of the second display device, and display content of the position adjustment images.

8. A method for detecting a position of a display device comprising;
detecting a distance across a non-display region between a display screen of a first display device and a display screen of a second display device based on results of detection, by a first light detection unit that detect light from pixels, of a position adjustment image displayed on the display screen of the first display device, results of detection, by a second light detection unit that detects light from pixels, of a position adjustment image displayed on the display screen of the second display device, and display content of the position adjustment images, the first light detection unit is located at a position facing the display screen on the first display device, and the second light detection unit is located at a position facing the display screen on the second display device that is provided adjacent to the first display device.
